(19) United States
(12) Patent Application Publication
(10) Pub. No.: US 2019/0160903 A1
(43) Pub. Date: May 30, 2019

(54) METHOD AND INSTALLATION FOR PRODUCING A FIBER PLASTIC COMPOSITE COMPONENT USING SUB-PREFORMS

(71) Applicant: ZF Friedrichshafen AG, Friedrichshafen (DE)

(72) Inventors: Mathias Schramm, Bamberg (DE); Alexander Hamacher, Gerolzhofen (DE); Ignacio Lobo Casanova, Markdorf (DE)

(73) Assignee: ZF Friedrichshafen AG, Friedrichshafen (DE)

(21) Appl. No.: 16/309,403

(22) PCT Filed: May 15, 2017
(86) PCT No.: PCT/EP2017/061553

§ 371 Date: Dec. 12, 2018

(30) Foreign Application Priority Data
Jun. 17, 2016 (DE) DE102016210891.3

(51) Int. Cl. B60G 7/00

(52) U.S. Cl. CPC B60G 7/001; B29C 70/543

(57) ABSTRACT

A method for the production of a fiber plastic composite component may include the following steps: creating a load-adapted multilayer preform structure made of pre-fabricated multi-layered sub-preforms, and inserting the preform structure into a form-shaping tool. A system for the production of a fiber plastic composite component may include the following: a first manufacturing station for forming a load-adapted multi-layer preform structure from prefabricated multilayered sub-preforms, and a form-shaping tool for consolidating the preform structure.

### RELATED APPLICATIONS

This application is a filing under 35 U.S.C. § 371 of International Patent Application PCT/EP2017/061553, filed May 15, 2017, and claiming priority to German Patent Application 10 2016 210 891.3, filed Jun. 17, 2016. All applications listed in this paragraph are hereby incorporated by reference in their entireties.

### TECHNICAL FIELD

The present disclosure relates to a method and an equipment for the production of a fiber plastic composite component, in particular for the chassis of a motor vehicle.

### BACKGROUND

The DE 10 2012 221 404 A1 reference describes a component that is consisting of fiber composite, in particular for a chassis of a motor vehicle, which is made up of individual fiber layers.

The DE 10 2014 214 827 A1 reference of the same applicant describes a method for the production of a suspension arm for a motor vehicle that is basically made from a fiber plastic composite structure, comprising the following steps:
Creating a preform structure with a load-adapted fiber orientation,
Inserting the preform structure into a form-shaping tool,
Consolidating the preform structure within the tool,
Removing and further processing of the suspension arm.

The creation of a usually multilayered preform structure is complex and time-consuming. Individual layers that are customized and/or formed of various semi-finished fibers are usually placed individually according to a specific location or draping plan. However, such a procedure is unsuitable for a use in series production.

Among other things, the DE 10 2014 205 479 A1reference describes an automated handling equipment in form of a robot or the like, that can arrange pre-cut parts made of fiber material for the production of a two-dimensional reinforcement structure in an automated manner.

### BRIEF DESCRIPTION OF THE DRAWINGS

FIG. 1 schematically illustrates the manufacturing of a transverse leaf spring in accordance with the invention.

FIG. 2 schematically illustrates the manufacturing of a three-point linkage in accordance with the invention.

### DETAILED DESCRIPTION

It is an objective of the embodiments of the present disclosure to simplify the production of fiber plastic composite components.

This is achieved by means of a method in accordance with the invention according to patent claim 1 and by means of an equipment (device) in accordance with the invention according to the independent claim. By means of a further supplementary claim, the invention also extends to a preferred use for the production of a transverse leaf spring or a three-point linkage for the chassis of a motor vehicle. Preferred further developments and embodiments of the invention can be derived from the dependent patent claims, the following description and the drawing in the same manner for all subject matters of the invention.

The method in accordance with the invention comprises at least these steps:
Creating a load-adapted multilayer preform structure made of pre-fabricated multi-layered sub-preforms, and
Consolidating the preform structure in a form-shaping tool.

The invention thus intends that the multilayer preform structure is not created or assembled from individual pre-cut parts made of fiber material as it was done previously, but that it is made from different and/or identical sub-preforms. For this purpose, the preform structure that is to be produced is separated into useful sub-preforms, which can be prefabricated in a first manufacturing station or the like, e.g. also at a supplier. In a second manufacturing station or the like, the preform structure can then be manufactured from the sub-preforms. This procedure is less complex and time consuming. The procedure in accordance with the invention is thus also suitable for the series and particularly for the large-scale production.

Another advantage of the invention is to be seen in that the integration of sensors, which e.g. detect a change of the fiber composite structure (as it is described in the DE 10 2014 214 827 A1), can be accomplished in a simpler way with sub-preforms.

A multilayered preform structure is understood to be a flat textile-like unfinished part made of reinforcement fibers (e.g. carbon or glass fibers), which forms the fiber-containing reinforcement structure of the component that is to be manufactured. The preform structure features several pre-cut parts that are made of preferably dry semi-finished fiber material (i.e. a semi-finished fiber material or, where appropriate, also different semi-finished fiber materials, wherein it is referred to e.g. layers, also UD-layers, fabric, knitted fabric and the like), which are assembled or arranged in consideration of the load that will affect the finished component. The preform structure can be flexible and can be inserted into a form-shaping tool in such a way that its shape will adapt to the cavity of the tool, e.g. an RTM tool. The preform structure can also already feature a spatial shaping and be flexible only to a certain degree. The preform structure can be formed outside the tool and then be placed into the tool or it can be directly formed or assembled inside the cavity of the tool. The basically known manner of forming and consolidating, i.e. the embedding into a plastic matrix can then be carried out within the tool. To accomplish this, the plastic matrix (e.g. a resin) is injected into the cavity, which infiltrates the preform structure and subsequently hardens, e.g. aided by the influence of pressure and/or temperature. Afterwards, the fiber plastic composite component can be removed and, if needed, be processed further.

A sub-preform is understood to be a simplified preform (flat textile-like unfinished part made of reinforcement fibers), which basically forms a subassembly or a module for the preform structure. In like manner to the preceding explanations, a sub-preform is formed from a plurality of preferably dry semi-finished pre-cut fiber materials (different or also identical pre-cuts that are made of one or also different semi-finished fiber materials), which are assembled and generally arranged on top of each other in consideration of the load that will affect the finished component (i.e., for example, also with different fiber orientations). A sub-preform can be both flat (2-dimensional) as well as spatial (2.5- or 3-dimensional). A sub-preform can be flexible as well as rigid to a certain degree. In a sub-preform, the individual pre-cut parts are joined together, in particular by means of a thermoplastic binder (e.g. in the form of a binding powder that is already applied to the semi-finished fiber material), and these are in particular also pre-compacted.

Preferably, it is intended that in a step prior to creating the preform structure, at least some of the sub-preforms are produced at the same time. By means of such a parallel prefabrication, a considerable time saving can be accomplished. The prefabricated sub-preforms can be processed directly or they can be stored temporarily. As it was already explained, the sub-preforms can also be manufactured by a supplier.

As it was shown before, the individual layers of the sub-preforms can be joined together by means of a thermoplastic binder, whereas the sub-preforms are preferably joined together by means of a thermosetting binder when the preform structure is produced. Due to the thermo joining, the individual fiber layers or individual layers are fixed with regards to each other, even for a spatial formation, and a shifting of the layers is prevented. However, the tool temperature within the tool usually exceeds the softening temperature of the thermoplastic binder, due to which a thermo bonding of the sub-preforms to each other is not suitable. A two-stage binder (for example a binding powder) is used in particular, which features both thermoplastic and thermosetting (i.e. crosslinking) characteristics. By using this two-stage binder, it is possible to join together and to optionally pre-compact the sub-preforms in the thermoplastic range of the binder (i.e. at a lower temperature range) and to subsequently fix them together with other sub-preforms (or individual layers) (crosslinking characteristics of the binder at a higher temperature range). As a result, at each stage of the manufacturing process, it is possible to obtain easily manageable, flexible or also rigid sub-preforms that, in principle, can be combined with each another as desired.

There may be different variants for the preform structure (e.g. for different vehicle types) or individual adaptions (e.g. for vehicle tuning). In addition to a batch production, the invention also allows an individual production or a series production of a variant. For this purpose, the sub-preforms are prefabricated e.g. as standardized parts or standard components, wherein there may also be different designs for the individual parts (e.g. with different layer structures and/or with sensors, e.g. in the form of smart textiles), and these are provided in sufficient quantities in order that they form a modular system, from which the preform structure, or the preform structures that were produced in series, can be created or assembled individually or in a variant-specific manner by means of a suitable selection. If required, sub-preforms with sensors (see above) can also be used. The individual or variant-specific creation is carried out particularly in an automated manner, for example by means of a production planning and control system (PPS system).

Preferably, all steps of the method in accordance with the invention are carried out in an automated manner, e.g. by means of a system according to the invention, which is explained in more detail in the following.

The equipment in line with the invention, which is particularly operating in an automated manner comprises:
a (second) manufacturing station, that creates or produces a load-adapted multi-layer preform structure from prefabricated multilayered sub-preforms; and
a form-shaping tool, e.g. an RTM tool, in which the preform structure is consolidated.

The (second) manufacturing station is particularly designed to create the preform structure individually or in a variant-specific manner from the prefabricated sub-preforms, as it was explained above.

Preferably, the equipment according to the invention further comprises
a further upstream (first) manufacturing station, in which the sub-preforms are prefabricated, wherein this manufacturing station preferably features a plurality of (parallel) production lines, in which several identical and/or different sub-preforms are prefabricated simultaneously.

The equipment according to the invention is particularly designed for series production of fiber plastic composite components, due to which e.g. identical and/or different sub-preforms are continuously produced in the first manufacturing station, from which preform structures are then manufactured in the second manufacturing station, in particular in an individual or variant-specific manner, which in turn are subsequently consolidated in the tool.

The additional or second manufacturing station is preferably designed for an individual production and/or variant production in accordance with the modular principle by means of combining the sub-preforms that were prefabricated in the first manufacturing station, which are supplied to the second manufacturing station.

In particular with regard to an individual production or a series production of a variant, the tool or the tool device can feature multiple different cavities, which are used depending on the component variant that is to be manufactured.

Among other things, the equipment according to the invention features the advantages of low complexity and a high production capacity.

Possible applications of the invention are the manufacturing of a transverse leaf spring or of a three-point linkage, as it is explained in more detail below with reference to the drawing. The characteristics that are shown in the drawing or which are explained in the following, even when they are detached from any specific combination, can be general characteristics of the invention and can be further developed the invention.

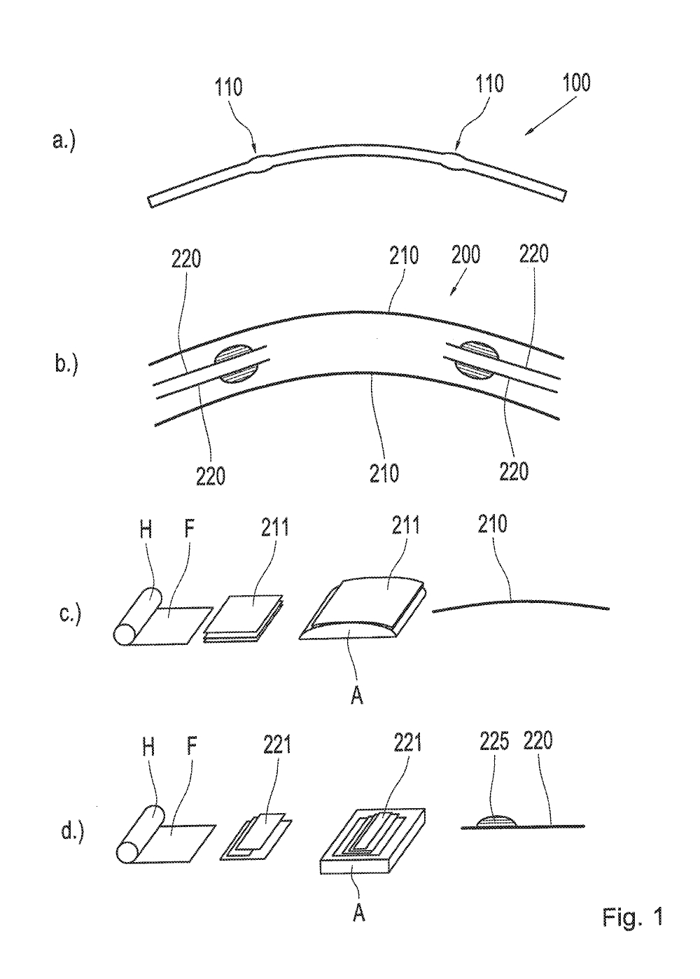

Referring now to the figures, FIG. 1a shows a side view of a transverse leaf spring 100 of a motor vehicle, wherein it is referred to a fiber plastic composite component featuring a plurality of reinforcement layers. The transverse leaf spring 100 has two thickened sections 110, which serve as bearing locations. The transverse leaf spring 100 thus features a variable thickness. The thick spots or thickenings 110 are thus far produced by means of a local introduction of individual fiber layers. At the thick spots 110, the transverse leaf spring 100 consists of e.g. up to seventy individual layers.

The invention thus intends that the complex preform structure for the transverse leaf spring 100, which contains the reinforcement fibers, is no longer manufactured from individual layers, but that it is created or manufactured from prefabricated sub-preforms. FIG. 1b shows the preform structure 200 for the transverse leaf spring 100. The preform structure 200 that is close to the contour of the transverse leaf spring 100 comprises two cover layers 210 and four wedge-shaped inserts 220, which are respectively formed from a plurality of individual semi-finished fiber products blanks, as it will be explained in the following. Instead of being made up of up to seventy individual layers, the preform structure 200 is formed of only six sub-preforms 210 and 220 which is much simpler and faster.

FIG. 1c illustrates the manufacturing of the sub-preforms 210 that are forming the cover layers. From the semi-finished fiber product F that is provided on the semi-finished product roll H, identical blanks 211 are produced by means of a separating device, which are then arranged on top of each other, if necessary, with a different fiber orientation, and placed in a shape-following way on a deposit area A with a curved surface. The individual layers 211 are pre-compacted and thermo joined together by means of a thermal activation of a binder powder that is applied on the semi-finished fiber product F, so that a shell-like sub-preform 210 with continuous layers is formed that is 2.5-dimensionally formed spatially and that is at least partially rigid.

In like manner, the insert wedges 220 are manufactured as it is shown in FIG. 1d, wherein the manufacturing is preferably carried out parallel to the production of the cover layers 210. The same semi-finished fiber products F, a different semi-finished fiber product or also various semi-finished fiber products can be used as raw material. However, the blanks 221 are different and are placed and joined together in such a way on a deposit area A, which features a flat surface, possibly also with a different fiber orientation, that the resulting sub-preform 220, as it is shown in the right depiction, is formed with a wedge-like cross section contour.

Preferably, the manufacturing of the sub-preforms 210 and 220 is carried out in an automated manner. The possibility of an individual production or of a production of variants is explained above.

The prefabricated sub-preforms 210 and 220 are now arranged to form a preform structure or overall preform 200 in the manner shown in FIG. 1b, in particular in an automated manner, wherein the sub-preforms 210 and 220 are not stacked or piled next to each other, but on top of each other. By means of a thermal activation of the binding powder in a higher temperature range, the sub-preforms 210 and 220 are joined together by means of a thermosetting at least in some sections. The preform structure 200 that is thus created may now be consolidated into a tool (e.g. an RTM tool), as it was explained above, wherein the locally high layer structures 225 of the wedge-like sub-preforms 220 form the thick spots 110 of the transverse leaf spring 100.

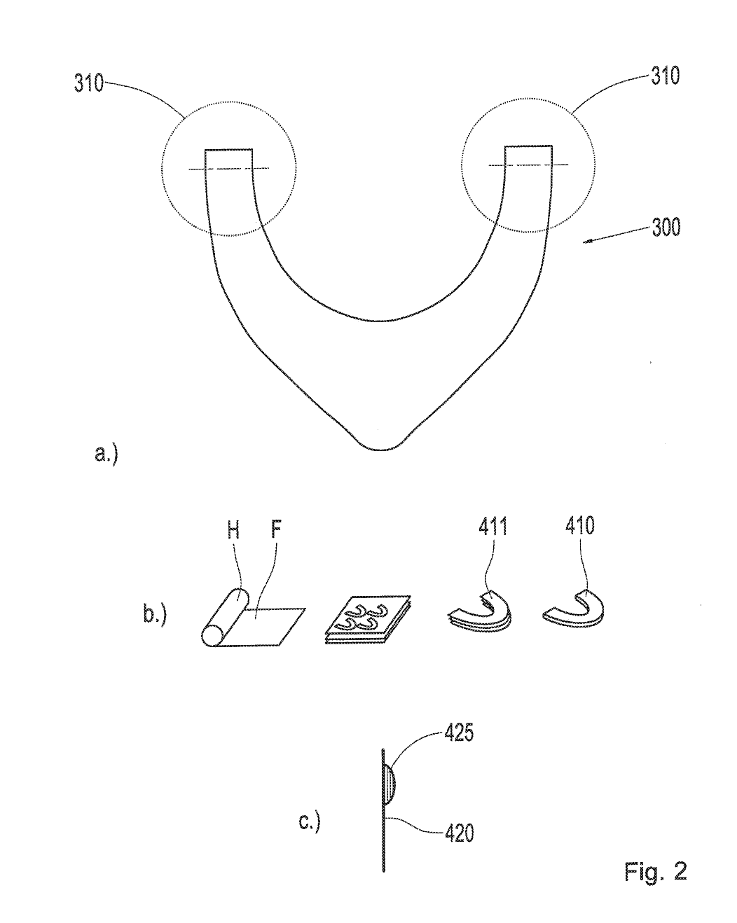

FIG. 2a shows a top view of a three-point linkage 300, such as it is known e.g. from the DE 10 2014 214 827 A1. The two arms of the three-point linkage 300 feature bearing seats for rubber bearings at their ends 310 that are marked by borders and are designed to be locally thicker in the region of these bearing seats.

The preform structure or overall preform for the manufacturing of the three-point linkage 300 is formed by two horseshoe-shaped sub-preforms 410 (see FIG. 2b) and a wedge-like sub-preform 420 that is inserted between them (see FIG. 2c) with locally high layer structures 425, which are used for the thickening at the arm ends. The manufacturing of the horseshoe-shaped sub-preforms 410 from semi-finished fiber blanks 411 is illustrated in FIG. 2b. The manufacturing of the wedge-like sub-preforms 420 with the locally high layer structures 425 is carried out analogously to the procedure that is illustrated in FIG. 1d.

1. A method for the production of a fiber plastic composite component, the method comprising:
creating a load-adapted multilayer preform structure made of pre-fabricated multi-layered sub-preforms; and
inserting the preform structure (200) in into a form-shaping tool.

2. The method according to claim 1, wherein at least a portion of the sub-preforms are produced at the same time and prior to insertion into the preform structure.

3. The method according to claim 1, wherein individual layers of the sub-preforms are joined together by a thermoplastic binder.

4. The method according to claim 1, wherein the pre-fabricated sub-preforms form a modular system, and wherein the preform structure is assembled integrally or in a variant-specific manner from the modular system.

5. A system for the production of a fiber plastic composite component comprising:
a first manufacturing station for forming a load-adapted multi-layer preform structure from prefabricated multilayered sub-preforms; and
a form-shaping tool for consolidating the preform structure.

6. The system according to claim 5, wherein the first manufacturing station is configured to create the preform structure integrally or in a variant-specific manner from the pre-fabricated sub-preforms.

7. The system according to claim 5, further comprising:
a second manufacturing station located upstream from the first manufacturing station, wherein the sub-preforms are prefabricated at the second manufacturing station.

8. The system according to claim 7, wherein the second manufacturing station includes a plurality of production lines, each production line being configured to prefabricate a sub-preform.

9. The system according to claim 5, wherein the form-shaping tool features a plurality of cavities.

10. (canceled)

11. The method of claim 1, wherein the fiber plastic composite component includes a transverse leaf spring.

12. The method of claim 1, wherein the fiber plastic composite component includes a three-point linkage.

13. The method of claim 1, wherein the sub-preforms are joined together by a thermosetting binder when the preform structure is produced.

14. The method of claim 1, wherein the fiber plastic composite component is a component for a chassis of a motor vehicle.

15. The system of claim 5, wherein the fiber plastic composite component includes a transverse leaf spring.

16. The system of claim 5, wherein the fiber plastic composite component includes a three-point linkage.

17. The system of claim 9, wherein each of cavity of the plurality of cavities has a different shape.

18. The system of claim 9, wherein at least one cavity of the plurality of cavities has a different shape than a second cavity of the plurality of cavities.
